(19) United States
(12) Patent Application Publication
(10) Pub. No.: US 2026/0044714 A1
(43) Pub. Date: Feb. 12, 2026

(54) LARGE LANGUAGE MODEL INFORMED RISK ASSESSMENT

(71) Applicant: Google LLC, Mountain View, CA (US)

(72) Inventors: Daniel Matthew Cer, Santa Clara, CA (US); Jinhyuk Lee, Sunnyvale, CA (US); Xiaoqi Ren, Bothell, WA (US); Wen Ding, Seattle, WA (US); Blair Yuxin Chen, San Jose, CA (US)

(21) Appl. No.: 18/800,438

(22) Filed: Aug. 12, 2024

(51) Int. Cl. G06N 3/0455

(52) U.S. Cl. CPC G06N 3/0455

(57) ABSTRACT

Aspects of the disclosure relate to pre-format embeddings used for model training, and in particular, training of dual encoder LLMs. For instance, a dataset batch of pairs of input text and one or more classification labels may be accessed. A unique identifier to each pair of input text and one or more classification labels may be assigned. The pairs of input text and one or more classification labels and assigned unique identifiers may be used to train a model to assign classification labels to textual inputs.

### BACKGROUND

Large language models (LLMs) may be trained using pre-processed datasets, that is data that has already been formatted into representations such as embeddings, and may be provided by various sources. For example, as in natural language processing, a word embedding may be a representation of a word in vector space, a sentence embedding is a representation of a sentence in vector space to capture meaning and context, a text embedding may be a representation of natural language in vector space, etc. These vectors may position semantically similar text near one another within the embedding space. Depending on the type of model to be trained, different datasets and embeddings may be used.

Various approaches can be used to improve model performance by making the classification examples look more like a retrieval problem. However, these approaches do not directly target training embedding model representations for downstream classification tasks, while also remaining compatible with existing training mixtures for embedding models. In other words, the models themselves must be adapted to accept new types of training data. In this regard, the features described herein describe approaches for improving embeddings by training on novel task types outside of the retrieval and similarity/relatedness matching tasks typically used to train dual encoder embeddings models.

### BRIEF SUMMARY

Aspects of the disclosure provide a method. The method includes accessing, by one or more processors, a dataset batch of pairs of input text and one or more classification labels; assigning, by the one or more processors, a unique identifier to each pair of input text and one or more classification labels; and using, by the one or more processors, the pairs of input text and one or more classification labels and assigned unique identifiers to train a model to assign classification labels to textual inputs.

In one example, assigning the unique identifier includes using a random number generator to generate the unique identifier for each pair of input text and one or more classification labels. In another example, assigning the unique identifier includes generating, for each of the pairs of input text and one or more classification labels, a fingerprint using raw text of a respective input textual embedding. In this example, assigning the unique identifier includes using a number generator to generate a random number for each pair of input text and one or more classification labels, and wherein each unique identifier includes a random number and a fingerprint. In another example, each pair of input text and one or more classification labels is arranged as a triple of inputs including the input text, a positive example, and a negative example. In another example, the model is a classification model that provides positive and negative classifications of the textual inputs. In another example, the model is a large language model (LLM). In this example, the LLM is configured as a dual encoder embeddings model. In another example, the input text of each pair is one of a sentence, a passage, or a document. In another example, the unique ID allows the model to avoid misidentifying positive examples within the dataset batch as negative examples for different inputs that share classification labels.

Another aspect of the disclosure provides a system comprising one or more processors. The one or more processors are configured to access a dataset batch of pairs of input text and one or more classification labels; assign a unique identifier to each pair of input text and one or more classification labels; and use the pairs of input text and one or more classification labels and assigned unique identifiers to train a model to assign classification labels to textual inputs.

In one example, the one or more processors are configured to assign the unique identifier includes by using a random number generator to generate the unique identifier for each pair of input text and one or more classification labels. In another example, the one or more processors are configured to assign the unique identifier includes by generating, for each of the pairs of input text and one or more classification labels, a fingerprint using raw text of a respective input textual embedding. In this example, the one or more processors are configured to assign the unique identifier includes by using a number generator to generate a random number for each pair of input text and one or more classification labels, and wherein each unique identifier includes a random number and a fingerprint. In another example, each pair of input text and one or more classification labels is arranged as a triple of inputs including the input text, a positive example, and a negative example. In another example, the model is a classification model that provides positive and negative classifications of the textual inputs. In another example, the model is a large language model (LLM). In this example, the LLM is configured as a dual encoder embeddings model. In another example, the input text of each pair is one of a sentence, a passage, or a document. In another example, the unique ID allows the model to avoid misidentifying positive examples within the dataset batch as negative examples for different inputs that share classification labels.

### BRIEF DESCRIPTION OF THE DRAWINGS

FIGS. 1A and 1B depict an example computer architecture in which the technology may be implemented.

FIG. 2 depicts an example architecture of a dual encoder embeddings model that may be used in aspects of the technology.

FIG. 3 depicts another example architecture of a dual encoder embeddings model that may be used in aspects of the technology.

FIGS. 4 and 5 are example matrixes of data in accordance with aspects of the disclosure.

FIG. 6 is an example table of data in accordance with aspects of the disclosure.

FIG. 7 is an example matrix of data in accordance with aspects of the disclosure.

FIG. 8 is an example table of data in accordance with aspects of the disclosure.

FIG. 9 is an example flow diagram according to aspects of the disclosure.

### DETAILED DESCRIPTION

### Overview

The technology relates to improving performance of models, such as large language models (LLM), by pre-formatting embeddings used for model training. As noted above, these models may be trained using pre-processed datasets, that is data that has already been formatted into representations such as embeddings, and may be provided by various sources. For example, as in natural language processing, a word embedding may be a representation of a word in vector space, a sentence embedding is a representation of a sentence in vector space to capture meaning and context, a text embedding may be a representation of natural language in vector space, etc. These vectors may position semantically similar text near one another within the embedding space. Depending on the type of model to be trained, different datasets and embeddings may be used.

Various approaches can be used to improve model performance by making the classification examples look more like a retrieval problem. However, these approaches do not directly target training embedding model representations for downstream classification tasks, while also remaining compatible with existing training mixtures for embedding models. In other words, the models themselves must be adapted to accept new types of training data. In this regard, the features described herein describe approaches for improving embeddings by training on novel task types outside of the retrieval and similarity/relatedness matching tasks typically used to train dual encoder embeddings models.

LLM models may be configured as dual encoder embeddings models may having two encoders. Each encode encodes an input (such as a string of text) into an embedding. Dual encoding embeddings models may achieve strong performance by leveraging the distillation of knowledge from LLMs into a retriever. A two-step distillation process may begin with generating diverse, synthetic paired data using an LLM, and thereafter, refining the data quality by retrieving a set of candidate results (e.g., answer or candidate passage) from each input (e.g., query). The positive and hard negative passages may also be relabeled using the same LLM. Such models may be used to train general purpose embeddings representations that are applied to a variety of downstream task types including: classification (such as classification pair), clustering, semantic similarity (such as semantic textual similarity), reranking, bitext mining, summarization (e.g., evaluation of generated text from another model), retrieval, retrieval augmented generation (RAG), data mining and analysis (e.g., clustering free-form text from surveys, mining training pairs for machine translation) as well as features that are combined with collections of other features for classification tasks, and so on.

Dual encoder embeddings models may be trained using dataset batches with predefined inputs that are paired with respective positive targets. As an example, for retrieval tasks, inputs may correspond to queries, while targets are sentences, passages or documents that should be retrieved in response to the query. During training, all of the inputs and targets may be embedded by the dual encoder embeddings model resulting in input embedding and target embeddings. A dot-product may be used to score each input embedding against all of the candidate target embeddings in a batch. The dot-product score for each input embedding and its positive target embedding may be used as a logit for the correct answer in a cross-entropy classification loss. In addition, the dot-products with all of the other target embeddings from other queries in the batch may be taken to be logits for incorrect labels.

This can be visualized using a matrix whereby all of the scores along the diagonal are the scores for the correct input-target pairings (e.g., a query and sentence, passage, or document pair) or positive examples, while the scores off the diagonal may correspond to the dual encoder embeddings model's preference for pairing an input (e.g., a query) with an incorrect target (e.g., sentence, passage, or document) or negative examples.

While using the dot-product scores along the diagonal as positive examples and everything else as negative examples works well for retrieval and similarity/relatedness matching tasks, these dot-product scores cannot be used directly for most classification tasks or rather, then the targets are classification labels. Naively providing tasks with classification labels to a dual encoder embeddings models will result in the score for an input's correct label appearing both along the diagonal and the off-the diagonal when another input example has the same target label. However, assuming just the diagonal is positive will lead to correct off diagonal pairs being erroneously included as negatives in loss.

To address this deficiency or rather the problem of off-diagonal positives being erroneously treated as negative classification examples (e.g., the red shading with check mark), each input and its positive target may be tagged with a unique identifier (unique ID). This may ensure that the correct target will have a distinct representation even when the same classification label appears multiple times for different inputs in the same training batch.

This approach may allow the dual encoder embeddings model to distinguish the negative examples within a dataset batch. Including a unique ID for each correct input, the target pair alone would allow the model to “cheat” and rely on the unique identifiers to always pair the correct input with the correct target, even when those pairs are incorrect. However, this can be addressed by including additional incorrect labels for each input as negatives. The negatives may be tagged with the same unique ID as the input and the correct target. This may allow the unique IDs to be used to identify candidate targets for each input, but without revealing which of the targets is correct. The features described herein may provide a framework to improve model training. The features described herein allow for the seamless incorporation of various datasets into a contrastive learning objective (e.g., classification tasks) without performance degradation on other tasks such as document retrieval. The unique IDs allows dual encoder embeddings models to be trained on classification tasks without any changes to the models themselves. Critically, since the task formulation also allows classification tasks encoded in this way to be readily mixed with the retrieval and similarity/relatedness matching tasks typically used to train dual encoder embeddings models. In addition, the features described herein may be helpful in general when training models on large collections of classification tasks as is necessary for instruction-tuning/instruction-following.

### Example Systems

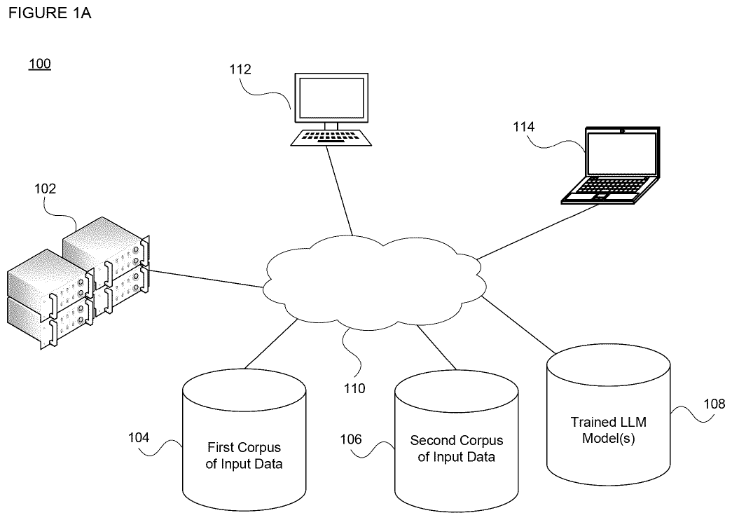

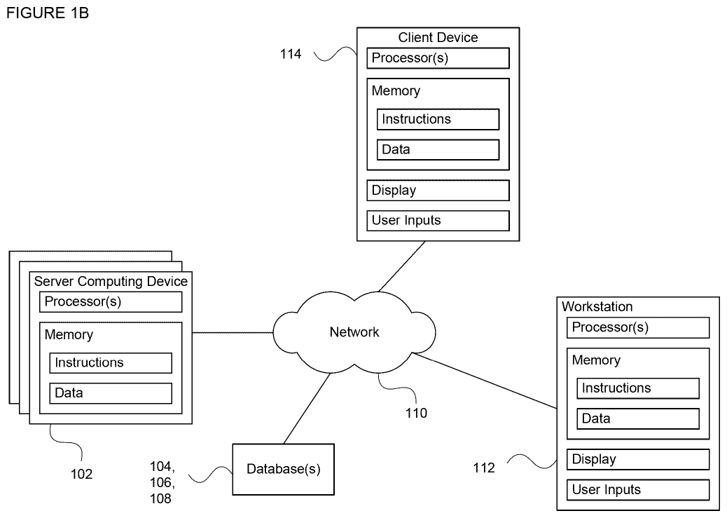

The LLM models described herein may be implemented using one or more tensor processing units (TPUs), GPUs, CPUs or other computing in accordance with the features disclosed herein. One example of a computing architecture is shown in FIG. 1A and FIG. 1B. In particular, FIG. 1A and FIG. 1B are pictorial and functional diagrams, respectively, of an example system 100 that includes a plurality of computing devices and databases connected via a network. For instance, one or more computing devices 102 may be implemented as a cloud-based server system. Databases 104, 106, 108 may store, e.g., first and second corpuses of input data, domain-specific text corpuses, baseline and/or trained LLM models, etc. While three databases are shown, such information may be stored in one or more databases that maintain different types of information. A server system, such as one or more computing devices 102, may access the databases via network 110. Client devices may include one or more of a desktop computer (e.g., computing device 112) (e.g., a workstation) and a laptop or tablet PC (e.g., computing device 114), although other types of client devices may be employed.

As shown in FIG. 1B, each of the computing devices 102 and 112-114 may include one or more processors, memory, data and instructions. The memory stores information accessible by the one or more processors, including instructions and data (e.g., LLM models and corpuses of input data) that may be executed or otherwise used by the processor(s). The memory may be of any type capable of storing information accessible by the processor(s), including a computing device-readable medium. The memory is a non-transitory medium such as a hard-drive, memory card, optical disk, solid-state, etc. Systems may include different combinations of the foregoing; whereby different portions of the instructions and data are stored on different types of media. The instructions may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance.

The processors may be any conventional processors, such as commercially available CPUs, TPUs, graphic processing units (GPUs), etc. Alternatively, each processor may be a dedicated device such as an ASIC or other hardware-based processor. Although FIG. 1B functionally illustrates the processors, memory, and other elements of a given computing device as being within the same block, such devices may actually include multiple processors, computing devices, or memories that may or may not be stored within the same physical housing. Similarly, the memory may be a hard drive or other storage media located in a housing different from that of the processor(s), for instance in a cloud computing system of one or more computing devices 102. Accordingly, references to a processor or computing device will be understood to include references to a collection of processors or computing devices or memories that may or may not operate in parallel.

Reference to “one or more processors” herein includes situations where a set of processors (e.g., two or more CPUs, TPUs, GPUs or any combination thereof) may be configured to perform one or more operations. Any combination of such a set of processors may perform individual operations or a group of operations. Therefore, reference to “one or more processors” does not require that all processors in the set must perform all of the operations. Rather, unless expressly stated, any one of the one or more processors may perform different operations when a set of operations is indicated. For instance, different processors may perform specific operations. For example, a first processor performs one or more iterations of accessing data set batches of embeddings, while a second processor performs one or more iterations of assigning unique identifiers, while a third processor performs one or more iterations of training a model. For another instance, multiple processors (e.g., multiple GPUs, TPUs, etc.) may each perform the various operations. In this example, each processor (e.g., GPU and/or TPU) performs a portion of accessing dataset batches of embeddings, assigning unique identifiers, and/or training a model in conjunction with the other processors (e.g., in parallel), and those same processors each perform a portion of accessing dataset batches of embeddings, assigning unique identifiers, and/or training a model.

The computing devices may include all of the components normally used in connection with a computing device such as the processor and memory described above as well as a user interface subsystem for receiving audio and/or other input from a user and presenting information to the user (e.g., text, imagery, videos and/or other graphical elements). The user interface subsystem may include one or more user inputs (e.g., at least one front (user) facing camera, a mouse, keyboard, touch screen and/or microphone) and one or more display devices (e.g., a monitor having a screen or any other electrical device that is operable to display information (e.g., text, imagery and/or other graphical elements). Other output devices, such as speaker(s) may also provide information to users. This enabled the client device to present information to a user, as well as to perform question-answering such as in a domain expert in-context conversation for active learning.

The user-related computing devices (e.g., 112-114) may communicate with a back-end computing system (e.g., one or more computing devices 102) via one or more networks, such as network 110. The network 110, and intervening nodes, may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, computing device 102 may include one or more server computing devices having a plurality of computing devices, e.g., a load balanced server farm or cloud computing system, that exchange information with different nodes of a network for the purpose of receiving, processing and transmitting the data to and from other computing devices. For instance, computing device 102 may include one or more server computing devices that are capable of communicating with any of the computing devices 112-414 via the network 110.

The techniques discussed herein may employ a self-attention architecture, e.g., the Transformer neural network architecture. This can include a decoder-only Transformer architecture. By way of example, the decoder self-attention sub-layer(s) may be configured, at each generation time step, to receive an input for each output position preceding the corresponding output position and, for each of the particular output positions, apply an attention mechanism over the inputs at the output positions preceding the corresponding position using one or more queries derived from the input at the particular output position to generate a updated representation for the particular output position. That is, the decoder self-attention sub-layer(s) may apply an attention mechanism that is masked so that it does not attend over or otherwise process any data that is not at a position preceding the current output position in the output sequence.

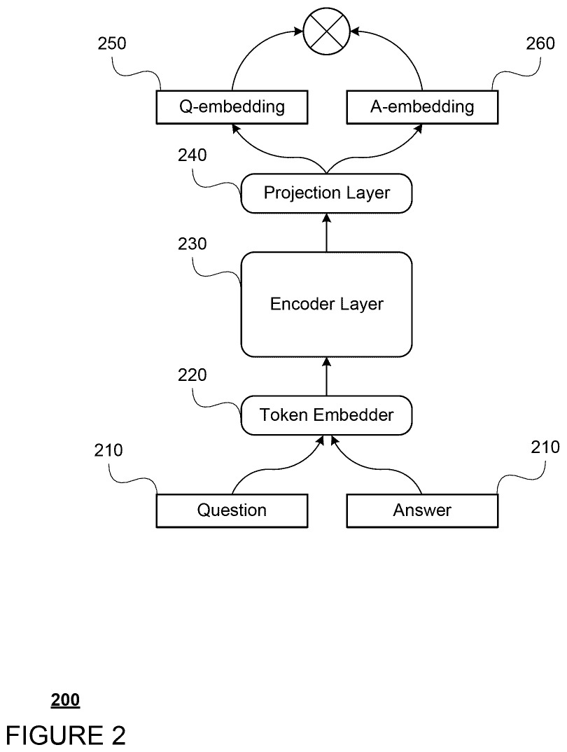

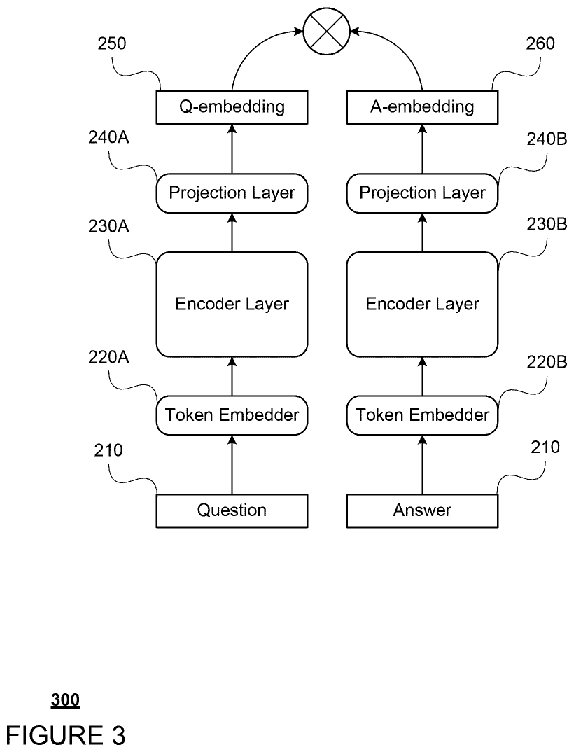

FIGS. 2 and 3 are example representations of transformer neural network architectures 200, 300. Each of FIGS. 2 and 3 represent different types of dual encoder configurations that can be used with LLMs. FIG. 2 represents a symmetric or twin dual encoder, while FIG. 3 represents an asymmetric dual encoder. As shown in FIG. 2 and FIG. 3, both arrangements depict an input sequence 210 (including a “Question” and an “Answer”), a token embedder layer (“Token Embedder”) 220, 220A, 220B, an encoder layer 230, 230A, 230B, a projection layer 240, 240A, 240B and an embedding space (represented by embeddings 250, 260). The token embedder layer 220, 220A, 220B, for example, may output a vector for each token (e.g., word or phrase) in the input which is then fed to the encoder layer 230, 230A, 230B. Each encoder layer 230, 230A, 230B first produces a fixed-length representation for its input and then applies a corresponding projection layer 240, 240A, 240B to generate the final embedding.

The input sequence 210 may include a dataset batch with predefined inputs that are paired with respective positive targets. As in the examples of FIGS. 2 and 3, for retrieval tasks, inputs may correspond to “questions” or “queries”, while targets are “answers” or “results” and may include sentences, passages or documents that should be retrieved in response to the query. Thus, as shown in FIGS. 2 and 3, together “Question” and “Answer” make up the input sequence 210. For classification tasks, inputs may correspond to sentences, passages or documents while the targets may include classification labels for those inputs. Other examples may include input textual sequences for translations (e.g., between different languages) or autocompletion of the input text.

The token embedder layer 220, 220A, 220B may be configured, for each input in the input sequence 210, to map the input to a numeric representation of the input in an embedding space, e.g., into a vector in the embedding space. The token embedder layer 220, 220A, 220B may then provide the numeric representations of the inputs to the encoder layer 230. The token embedder layer may be configured to map each network input to an embedded representation of the network input and then in some instances combine, e.g., sum or average, the embedded representation of the network input with a positional embedding of the input position of the input sequence 210 in order to generate a combined embedded representation of the input sequence. In some cases, the positional embeddings are learned. As used herein, “learned” means that an operation or a value has been adjusted during the training of the neural network. In other cases, the positional embeddings may be fixed and are different for each position or may be implemented as rotary position embeddings (RoPE) which encodes absolute position with a rotation matrix. The combined embedded representation may then be used as a numeric representation of the input sequence 210.

These vectors may be input into the encoder layer 230, 230A, 230B. In this regard, in the example of FIG. 2, encoder layer 230 may actually include a pair of encoders while in the example of FIG. 3, encoder layers 230A, 230B represent a pair of encoders. Each of the encoders of the encoder layers may include a plurality of subnetworks. Each of the encoder subnetworks may be to receive a respective encoder subnetwork input for each of the plurality of input positions and to generate a respective subnetwork output for each of the plurality of input positions. The encoder subnetwork outputs generated by the last encoder subnetwork in the sequence may then be used as the encoded representations of the network inputs. For the first encoder subnetwork in the sequence, the encoder subnetwork input is the numeric representations generated by the token embedder, and, for each encoder subnetwork other than the first encoder subnetwork in the sequence, the encoder subnetwork input is the encoder subnetwork output of the preceding encoder subnetwork in the sequence In the examples of FIGS. 2 and 3 each corresponding to retrieval tasks, one of the encoders of the pair may encode a representation of a “question” or “query” (Q-embedding 250) while another encoder of the pair may encode a representation of an “answer” or “result” (A-embedding 260) in the embedding space. As another instance, in the example of a classification task, one of the encoders of the pair may encode a representation of an input such as a sentence, passage or document while another encoder of the pair may encode a representation of a classification label in the embedding space. Other examples of tasks for which dual encoder embeddings models may be used may include, for example, clustering, semantic similarity (such as textual similarity), reraking, bitext mining, summarization (e.g., evaluation of generated text from another model), retrieval, retrieval augmented generation (RAG), data mining and analysis (e.g., clustering free-form text from surveys, mining training pairs for machine translation) as well as features that are combined with collections of other features for classification tasks, and so on.

In natural language processing, a word embedding may be a representation of a word in vector space, a sentence embedding is a representation of a sentence in vector space to capture meaning and context, a text embedding may be a representation of natural language in vector space, etc. These vectors may position semantically similar text near one another within the embedding space.

Dual encoding embeddings models may achieve strong performance by leveraging the distillation of knowledge from LLMs into a retriever. A two-step distillation process may begin with generating diverse, synthetic paired data using an LLM, and thereafter, refining the data quality by retrieving a set of candidate results (e.g., answer or candidate passage) from each input (e.g., query). The positive and hard negative passages may also be relabeled using the same LLM. Such models may be used to train general purpose embeddings representations that are applied to a variety of downstream task types including: Classification, Clustering, Semantic Similarity, Bitext Mining and Retrieval. One such compact and versatile dual encoder embeddings model is Gecko.

### Example Methods

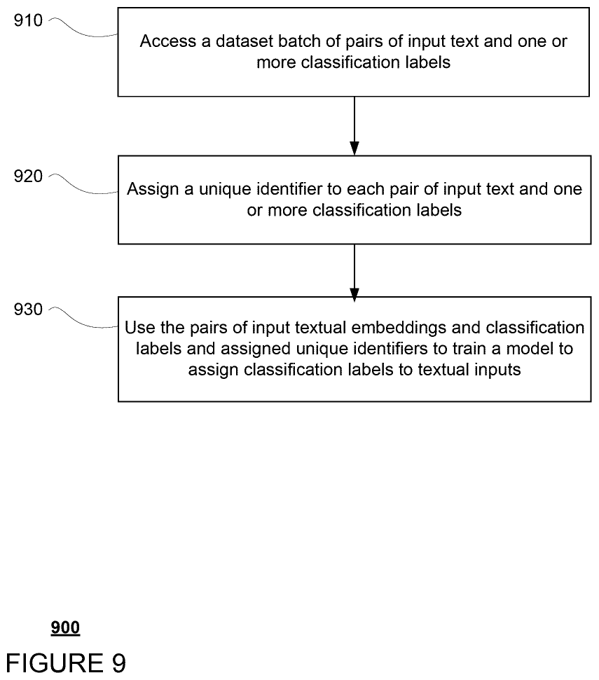

As noted above, the one or more computing devices 102 may pre-format embeddings used for model training, and in particular, training of LLMs configured as dual encoder embeddings models. FIG. 9 depicts an example flow diagram of a method 900 for pre-formatting embeddings which may be performed by one or more processors of the one or more computing devices 102. While FIG. 9 shows blocks in a particular order, the order may be varied and multiple operations may be performed simultaneously. Also, operations may be added or omitted.

At block 910, a dataset batch of pairs of input text and one or more classification labels is accessed. Dual encoder embeddings models may be trained using dataset batches with predefined inputs (e.g., for a classification task, “raw” text or a textual input x) that are paired with respective positive targets (e.g., for a classification task, a classification label y). As noted above, for retrieval tasks, inputs may correspond to queries, while targets are sentences, passages or documents that should be retrieved in response to the query. For classification tasks, textual inputs may correspond to sentences, passages or documents while the targets may include classification labels for those inputs. As described above, during training, all of the inputs and targets may be embedded by the dual encoder embeddings model resulting in input embedding and target embeddings. A dot-product or other vector similarity functions that rely on dot-product, such as cosine or arccosine approaches, may be used to score (“dot-product score”) each input embedding against all of the candidate target embeddings in a batch. The dot-product score for each input embedding and its positive target embedding may be used as a logit for the correct answer in a contrastive loss or cross-entropy classification loss. In addition, the dot-product scores with all of the other target embeddings from other queries in the batch may be taken to be logits for incorrect labels.

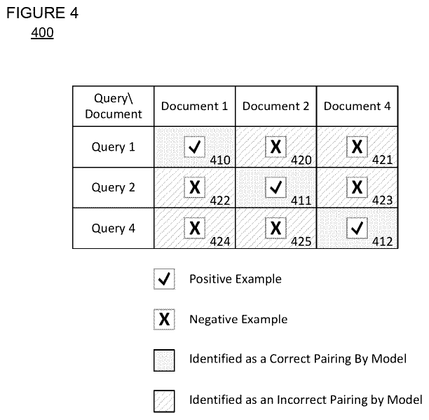

This can be visualized as depicted in FIG. 4 using a matrix 400. In this example, the matrix 400 depicts three queries (Query 1, Query 2, Query 3) each paired with a result (Document 1, Document 2, Document 3). Each document may represent a sentence, passage, or an entire document. The resulting value or score generated by the dual encoder embeddings model in each box is represented by the background shading to differentiate between correct pairings (boxes 410, 411, 412) determined by the dual encoder embeddings model and incorrect pairings (boxes 420, 421, 422, 423, 424, 425) determined by the dual encoder embeddings model. Actual relationships are represented by either a check mark, corresponding to a positive or correct relationship (e.g., positive examples), or an X, corresponding to a negative or incorrect relationship (e.g. negative examples). Accordingly, all of the scores/shading along the diagonal in the matrix (boxes 410, 411, 412) indicate correct input-target pairings or positive examples, while the scores off the diagonals (boxes 421, 424) indicate the dual encode embeddings model's preference for pairing a query with an incorrect document. Thus, FIG. 4 illustrates that the correct pairing of each query with its positive document is achieved when the relationships in the diagonal are considered positive and everything else is identified as an incorrect pairing (e.g., a batch negative).

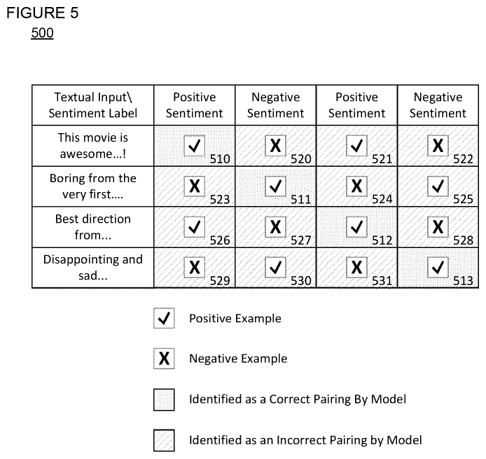

While using the dot-product scores along the diagonal as correct pairings and everything else as incorrect pairings works well for retrieval and similarity or relatedness matching tasks, these relationships do not extend directly to most classification tasks. In other words, when the targets are classification labels (rather than results for a query), the dot-product scores can lead to incorrect pairings by the dual encoder embeddings model. For example, naively providing tasks with classification labels to a dual encoder embeddings model while using contrastive loss may result in dot-product scores pushing the dual encoder embeddings model to identify correct pairings on the diagonal and incorrect pairings on the off diagonals when the pairings have the same target label (e.g., the same classification label). This is visualized in the example of matrix 500 of FIG. 5.

Matrix 500 depicts four textual inputs here, statements about a particular movie each paired with a classification label for a positive or negative sentiment. As with the example of matrix 400, the background shading differentiates between correct pairings and incorrect pairings generated by the dual encoder embeddings model, and the check marks and X's represent actual relationships. For example, the pairs of boxes 510, 511, 512, 513, 521, 525, 526, and 530 are all positive examples of classification labels (e.g., positive or negative sentiments for the paired sentences), while the pairs of boxes 520, 522, 523, 524, 527, 528, 529, 531 are all negative examples of classification labels (e.g., positive sentences paired with negative sentiment labels or negative sentences paired with positive sentiment labels). In this example, the scores for the off-diagonal pairs (e.g., boxes 521, 525, 526, 530) are shaded to indicate incorrect pairings generated by the dual encoder embeddings model. This thus depicts how assuming that the diagonal is positive will lead to correct off diagonal pairs being erroneously included as negatives in loss, or a “false negative problem”. In other words, positive examples in the off diagonal pairs (e.g., boxes 521, 525, 526, 530) may be incorrectly labeled as negative examples by the dual encoder embeddings model. As a result, learning can be very difficult for the dual encoder embeddings model.

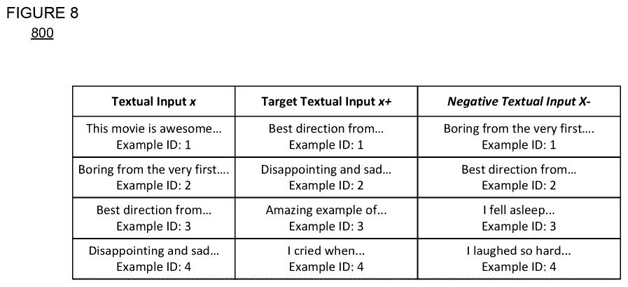

Returning to FIG. 8, at block 920, a unique identifier is assigned to each pair of input textual embeddings and classification labels. For instance, to address this deficiency or rather the false negative problems described above, each textual input (e.g., input text x) and its positive target (e.g., classification label y) may be tagged with a unique identifier (unique ID). This may ensure that the correct target will have a distinct representation even when the same classification label appears multiple times for different inputs.

Each unique ID may be an alphanumeric string of letters and/or numbers and may be assigned in order to be unique within the dataset batch being used to train the dual encoder embeddings model. The alphanumeric string may be generated using any number of different approaches such as a forward loop (e.g., increasing a numerical value by some number, such as 1, for each unique ID), a random number generator, a fingerprint of the input, or a combination of these (e.g., random number with appended fingerprint or vice versa). As an example, a fingerprint of the actual or “raw” text of the textual input (e.g., sentence, passage or document) may be generated using the TensorFlow Python library or other similar libraries. While the use of any one of forward loop, random number, or fingerprint may be sufficient to provide sufficiently unique values, combining two or more of these, the likelihood of collisions of the unique IDs within a dataset batch may be significantly reduced.

Returning to FIG. 9, at block 930, the pairs of input textual embeddings and classification labels and assigned unique identifiers are used to train a model to assign classification labels to textual inputs. In other words, the textual inputs, classification labels and unique IDs may then be used to train a dual encoder embeddings model. This may allow the dual encoder embeddings model to distinguish between negative examples within the dataset batch and avoid identifying false negative examples. In other words, the unique ID allows the model to learn significantly better representations since during training the model would not consistently determine that the model is wrong even when the predictions are actually correct, and therefore may allow the model to avoid misidentifying positive examples within the dataset batch as negative examples for different inputs that share classification labels.

Including a unique ID for each correct input and target pair alone would allow the model to “cheat” and rely on the unique IDs to always pair the correct input with the correct target. This may result in the model failing to learn from positive training examples if or when the model learns that unique IDs can be used to unambiguously identify the correct answer. This can be addressed by including additional incorrect classification labels (e.g., negative classification y−) for each textual input as negative examples. The negative classification label may be an incorrect classification label or a classification label other than classification label y. The negative examples may be tagged with the same unique ID as the input (x) and the correct target classification label (y). This may allow the unique IDs to be used to identify candidate targets for each input, but without revealing which of the targets is correct. For example, for each triple (x, y, y−), a unique ID may be assigned. In other words, the same unique ID may be appended to each of x, y, and y. This may effectively make the in-batch negatives (e.g., false negatives) trivial for the model to distinguish, because if the unique ID does not match, then the candidate label is never the correct answer. Thus, the model can disregard the false negatives and focuses on differentiating y and y− for a given x.

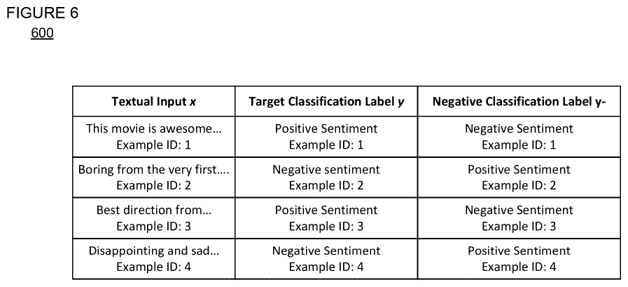

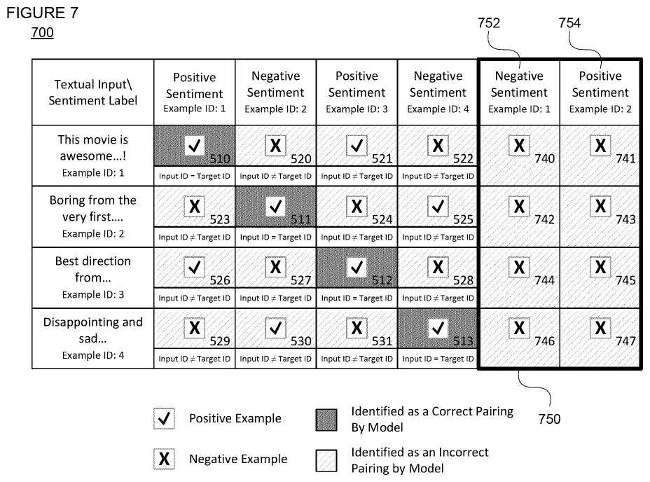

FIG. 6 is an example table 600 of training triples. In this example, in each row of the table data representing textual inputs (x) is paired with both target classification labels (e.g., correct classification label y) and negative classification labels (e.g., classification label y−). Each row of the table is also assigned a common unique ID (e.g., Example ID: 1, 2, 3, or 4). The unique IDs can then be used during training to differentiate between textual inputs and labels associated with different unique IDS. This may be demonstrated by the example of FIG. 7.

Matrix 700 of FIG. 7 depicts the four textual inputs or statements from matrix 500 each paired with a negative classification label and a positive target classification label. As with the example of matrix 400 and 500, the background shading differentiates between correct pairings and incorrect pairings generated by the dual encoder embeddings model, and the check marks and X's represent actual relationships. For example, boxes 510, 511, 512, 513, 521, 525, 526, and 530 are all positive (correct) examples of classification labels (e.g., positive statement paired with positive sentiment labels or negative sentences paired with negative sentiment labels), while boxes 520, 524, 527, 528, 529, 531 are all negative (incorrect) examples of classification labels (e.g., positive statement paired with negative sentiment labels or negative statement paired with positive sentiment labels). In this example, the off-diagonal scores (boxes 521, 525, 526, 530) are shaded to indicate incorrect pairings generated by the dual encoder embeddings model. The matrix 700 also depicts the unique IDs (IDs) for the textual inputs and classification labels for reference. In this regard, when each textual input is paired with its correct classification label, the example ID of the textual input matches the unique ID of the target label as shown in boxes 510, 511, 512, and 513. Similarly, when each textual input is paired with a classification label that does not share the same unique ID, the model may determine that the textual input and classification label should not be paired as shown in boxes 520-531.

In addition, referring to boxes 740-747 within area 750 of the matrix, the negative classification labels may be tagged with the same unique ID as the textual inputs (only two being shown for simplicity). For example, column 752 includes boxes 740, 742, 744, 746 which correspond to the negative classification label (y−) for Example ID: 1. Similarly, column 754 includes boxes 741, 743, 745, 747 which correspond to the negative classification label (y−) for Example ID: 2.

The use of unique IDs may also enable the direct replacement of classification labels (y) with other text (x+) having the same classification label without needing to make any additional or more substantial modifications to the input or target text. For example, given a textual input x (e.g., an embedding for a sentence, passage or document) with a classification label y, each textual input x may be paired with textual input x⁺, which shares the same classification label y. The textual input x⁺ may be used as a positive target for the textual input x. For example, turning to table 800 of FIG. 8, the textual inputs of FIG. 6 are paired with positive and negative examples. In this regard, each of the textual inputs x is paired with another textual input x+ with the same target classification label y. As an example, as shown in the example of FIG. 6, the textual inputs “This movie is awesome . . . ” and “Best direction from . . . ” are each associated with the same classification label, “Positive Sentiment”. As such, as depicted in FIG. 8, the textual input “Best direction from . . . ” is identified as a positive example x+ for the textual input x “This movie is awesome . . . ” Similarly, the textual inputs “Boring from the very first . . . ” and “Disappointing and sad . . . ” are each associated with the same target classification label, “Negative Sentiment”. As such, as depicted in FIG. 8, the textual input “Disappointing and sad . . . ” is identified as a positive example x+for the textual input “Boring from the very first . . . ” Of course, these are merely examples and various other permutations and combinations are also possible. In some instances, textual input x+may overlap other positive examples (e.g., include part or all of the same sentence, passage, or document) within the same dataset batch.

In addition, a negative textual input x⁻ may be generated or identified by selecting a textual input which has any other classification label other than y. The selection of the negative input may be random. As an example, as shown in the example of FIG. 6, “Boring from the very first . . . ” is associated with a classification label “Negative Sentiment” which is a classification label other than “Positive Sentiment”. As such, as depicted in the example of FIG. 8, the textual input “Boring from the very first . . . ” is identified as a negative example x− for the textual input x “This movie is awesome . . . ” Similarly, the textual input “Best direction from . . . ” is associated with a classification label “Positive Sentiment” which is a classification label other than “Negative Sentiment”. As such, as depicted in the example of FIG. 8, the textual input “Best direction from . . . ” is identified as a negative example x− for the textual input x “Boring from the very first . . . ” In some instances, textual input x+ may overlap other positive examples (e.g., include part or all of the same sentence, passage, or document) within the same dataset batch.

The result is a triple of textual inputs (x, x⁺, x⁻) that may be assigned a unique ID as described above and as depicted in the example of FIG. 8. In other words, the same unique ID may be appended to each of x, x+, and x−. For example, one triplet may include (“This movie is awesome . . . ”, “Best direction from . . . ”, “Boring from the very first . . . ”), and another triplet may include (“Boring from the very first . . . ”, “Disappointing and sad . . . ”, “Best direction from . . . ”). Each of these triplets may be associated with the same unique ID. For example, as shown in FIG. 8, the triple (“This movie is awesome . . . ”, “Best direction from . . . ”, “Boring from the very first . . . ”) is associated with Example ID: 1, and the triple (“Boring from the very first . . . ”, “Disappointing and sad . . . ”, “Best direction from . . . ”) is associated with Example ID: 2. Of course, these are merely examples and various other permutations and combinations are also possible. These triples and unique IDs may be used in conjunction with other such triples paired with other unique IDs to train a dual encoder embeddings model.

These unique IDs have been used in conjunction with the aforementioned Gecko models and have also demonstrated improvements to FRet (Few-shot Prompted Retrieval) models (including the transformer-based neural retrieval T5X Retrieval framework, T5-library based) models. Within the FRet models, the unique IDs described herein are the primary factor contributing to an improvement in the MTEB (massive text embedding benchmark) classification task overall score 72.2% to 80+%, outperforming all models on the public leaderboard on classification. In addition, the unique IDs also contributed to improvements in STS (semantic textual similarity) benchmark.

The features described herein may provide a framework to improve model training. The features described herein allow for the seamless incorporation of various datasets into a contrastive learning objective (e.g., classification tasks) without performance degradation on other tasks such as document retrieval. The unique IDs allows dual encoder embeddings models to be trained on classification tasks without any changes to the models themselves. Critically, since the task formulation also allows classification tasks encoded in this way to be readily mixed with the retrieval and similarity/relatedness matching tasks typically used to train dual encoder embeddings models. In addition, the features described herein may be helpful in general when training models on large collections of classification tasks as is necessary for instruction-tuning/instruction-following.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined herein.

1. A method comprising:
accessing, by one or more processors, a dataset batch of pairs of input text and one or more classification labels;
assigning, by the one or more processors, a unique identifier to each pair of input text and one or more classification labels; and
using, by the one or more processors, the pairs of input text and one or more classification labels and assigned unique identifiers to train a model to assign classification labels to textual inputs.

2. The method of claim 1, wherein assigning the unique identifier includes using a random number generator to generate the unique identifier for each pair of input text and one or more classification labels.

3. The method of claim 1, wherein assigning the unique identifier includes generating, for each of the pairs of input text and one or more classification labels, a fingerprint using raw text of a respective input textual embedding.

4. The method of claim 3, wherein assigning the unique identifier includes using a number generator to generate a random number for each pair of input text and one or more classification labels, and wherein each unique identifier includes a random number and a fingerprint.

5. The method of claim 1, wherein each pair of input text and one or more classification labels is arranged as a triple of inputs including the input text, a positive example, and a negative example.

6. The method of claim 1, wherein the model is a classification model that provides positive and negative classifications of the textual inputs.

7. The method of claim 1, wherein the model is a large language model (LLM).

8. The method of claim 7, wherein the LLM is configured as a dual encoder embeddings model.

9. The method of claim 1, wherein the input text of each pair is one of a sentence, a passage, or a document.

10. The method of claim 1, wherein the unique identifier allows the model to avoid misidentifying positive examples within the dataset batch as negative examples for different inputs that share classification labels.

11. A system comprising one or more processors configured to:
access a dataset batch of pairs of input text and one or more classification labels;
assign a unique identifier to each pair of input text and one or more classification labels; and
use the pairs of input text and one or more classification labels and assigned unique identifiers to train a model to assign classification labels to textual inputs.

12. The system of claim 11, wherein the one or more processors are configured to assign the unique identifier includes by using a random number generator to generate the unique identifier for each pair of input text and one or more classification labels.

13. The system of claim 11, wherein the one or more processors are configured to assign the unique identifier includes by generating, for each of the pairs of input text and one or more classification labels, a fingerprint using raw text of a respective input textual embedding.

14. The system of claim 13, wherein the one or more processors are configured to assign the unique identifier includes by using a number generator to generate a random number for each pair of input text and one or more classification labels, and wherein each unique identifier includes a random number and a fingerprint.

15. The system of claim 11, wherein each pair of input text and one or more classification labels is arranged as a triple of inputs including the input text, a positive example, and a negative example.

16. The system of claim 11, wherein the model is a classification model that provides positive and negative classifications of the textual inputs.

17. The system of claim 11, wherein the model is a large language model (LLM).

18. The system of claim 17, wherein the LLM is configured as a dual encoder embeddings model.

19. The system of claim 11, wherein the input text of each pair is one of a sentence, a passage, or a document.

20. The system of claim 11, wherein the unique identifier allows the model to avoid misidentifying positive examples within the dataset batch as negative examples for different inputs that share classification labels.
